(19) United States
(12) Patent Application Publication
(10) Pub. No.: US 2004/0143936 A1
(43) Pub. Date: Jul. 29, 2004

(54) Hinge structure for sales systems

(76) Inventor: Ming-Jer Hsu, Taipei (TW)

Correspondence Address: BIRCH STEWART KOLASCH & BIRCH, PO BOX 747, FALLS CHURCH, VA, 22040-0747, US

(21) Appl. No.: 10/352,225

(22) Filed: Jan. 28, 2003

(51) Int. Cl. E05D 3/10

(52) U.S. Cl. 16/367

(57) ABSTRACT

A hinge structure for sales systems bridging a body and a display screen includes an anchor bracket fastening to the body, a first axle pivotally fastening to the anchor bracket and a second axle connecting to the display screen and pivotally running through the first axle. The first axle has two ends coupling respectively with a first axle washer. The second axle has a pivotal connecting section located on a lower side thereof to pivotally couple with second axle washers. The display screen is tiltable forwards and rearwards through the first axle, and turnable left and right through the second axle.

### FIELD OF THE INVENTION

The present invention relates to a hinge structure for sales systems and particularly to a hinge stricture that has a first axle and a second axle to allow a display screen to turn left and right and tilt forwards and rear wards.

### BACKGROUND OF THE INVENTION

The commonly used sales systems at present generally have a display screen connecting to a computer processor through an axle. Operators may enter data and turn the display screen for an angle to face customers for viewing the items and prices of the purchased goods.

The structure of the bracket of the display screen for conventional cash registers include a rod, an axle, an connector, a rear cap and a sleeve. The axle has a shaft running through a hole on the top end of the rear cap into the rear cap. The sleeve is coupled on the shaft to allow the axle turnable on the top end of the cap. The cap is mounted onto the rear end of the computer processor of the cash register. Such a structure enables the display screen to be turned to face the customers. However, the bracket cannot be tilted forwards or rearwards. As the cash register counter and the cash register have specific elevations, customers who have smaller physical sizes have to raise their heads to see the display screen. It is inconvenience and annoying. Moreover many display screens these days have been changed to LCD panels. The picture quality on the LCD panels could be affected if not being viewed directly on the front side. In addition, the bracket for holding the display screen often is extended outside the cash register. It is easy to be damaged.

### SUMMARY OF THE INVENTION

Therefore the primary object of the invention is to resolve the aforesaid disadvantages. The invention has a first axle and a second axle to enable the display screen turnable left and right, and tilting forwards and rearwards. Hence the display screen not only can be adjusted in the forward and rearward directions, it also can be folded in the rearward direction when not in use to avoid damage.

In order to achieve the foregoing object, the hinge structure of the invention includes an anchor bracket, a first axle pivotally engaging with the anchor bracket and a second axle coupling with the display screen and pivotally engaging with the first axle. The first axle has two ends each is coupled with a first axle washer. The second axle has a pivotal connecting section on a lower side to pivotally couple with a second axle washer. The first axle enables the display screen to tilt forwards and rearwards. The second axle enables the display screen to turn left and right.

The foregoing, as well as additional objects, features and advantages of the invention will be more readily apparent from the following detailed description, which proceeds with reference to the accompanying drawings.

### BRIEF DESCRIPTION OF THE DRAWINGS

FIG. 1 is a perspective view of the invention.

FIG. 2 is an exploded view of the invention.

FIGS. 3A and 3B are schematic views of the invention for tilting forwards and rearwards.

FIGS. 4A and 4B are schematic views of the invention for turning left and right.

### DESCRIPTION OF THE PREFERRED EMBODIMENT

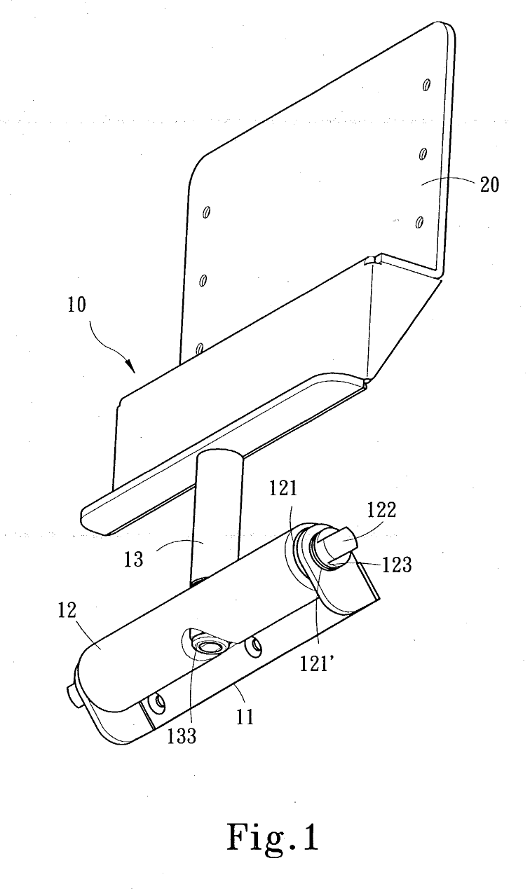

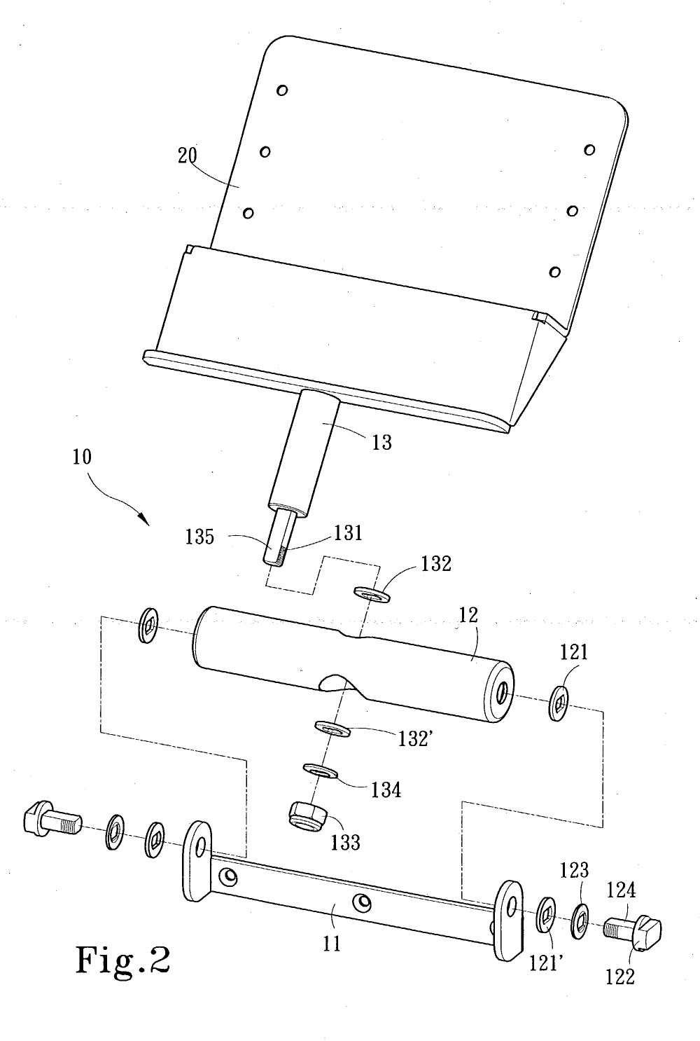

Referring to FIGS. 1 and 2, the hinge structure of the invention includes an anchor bracket 11, a first axle 12 pivotally engaging with the anchor bracket 11 and a second axle 13 pivotally coupling with the first axle 12. The first axle 12 has two ends coupling respectively with a first axle washers 121 and 121′, and each end is fastened by a first fastener 122 to fasten the first washer 121 and 121′. There is a first washer 123 located between the first fastener 122 and the first washer 121′. The first fastener 122 has screw threads formed thereon corresponding to the first axle 12 for fastening to the first axle 12. The first fastener 122 further has a retaining section 124. The second axle 13 has a pivotal connecting section 131 located on a lower side to pivotally couple with second axle washers 132 and 132′. The second axle 13 is engaged with a second fastener 133. There is a second washer 134 located between the second fastener 133 and the second axle washer 132′. The pivotal connecting section 131 has screw threads formed thereon corresponding to the second fastener 133 and a second retaining section 135. In order to increase the service life of the first and second axle washers 121, 121′, 132 and 132′ and the washers 123 and 134, they are all being processed by heat treatment in advance to increase their heat resisting and wear resisting properties.

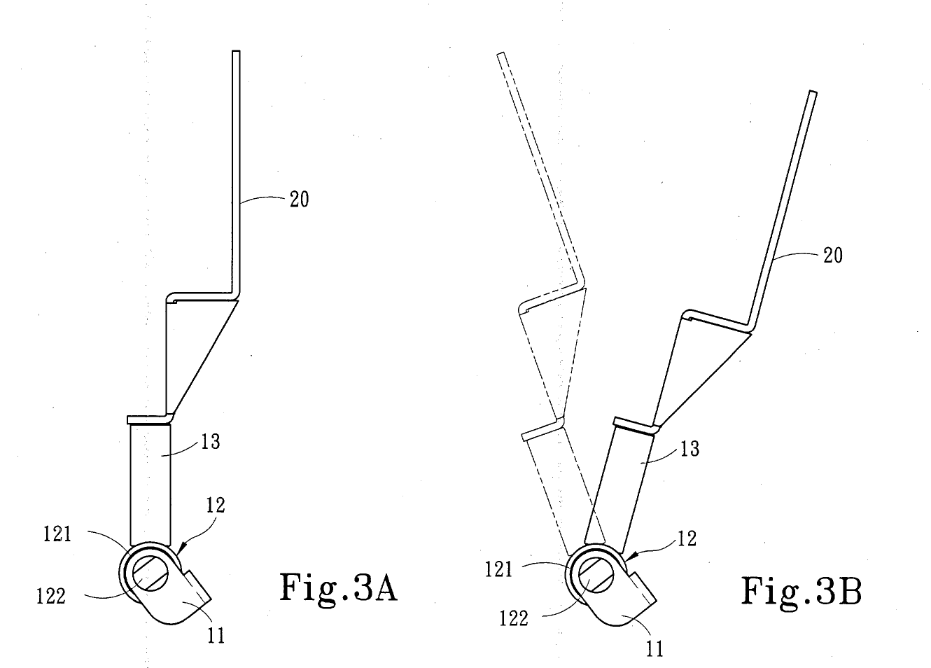

Refer to FIGS. 3A and 3B for the invention in use for tilting forwards or rearwards. When an user applies a force on the display screen 20, the display screen 20 may be tilted forwards or rearwards through the first axle washer 121, washer 123 and first fastener 122 of the first axle 12 (also shown in FIG. 2). Because of the screw threads and the first retaining section 124 on the first fastener 122, the first fastener 122 and the first axle washer 121 will be turned with the first axle 12 when the first axle 12 is tilted forwards or rearwards. In addition, the first axle 121 and the anchor bracket 11 may be coupled tightly because of the first fastener 122 thereby enables the display screen 20 to be adjusted forwards or rearwards and anchored in a stepless fashion.

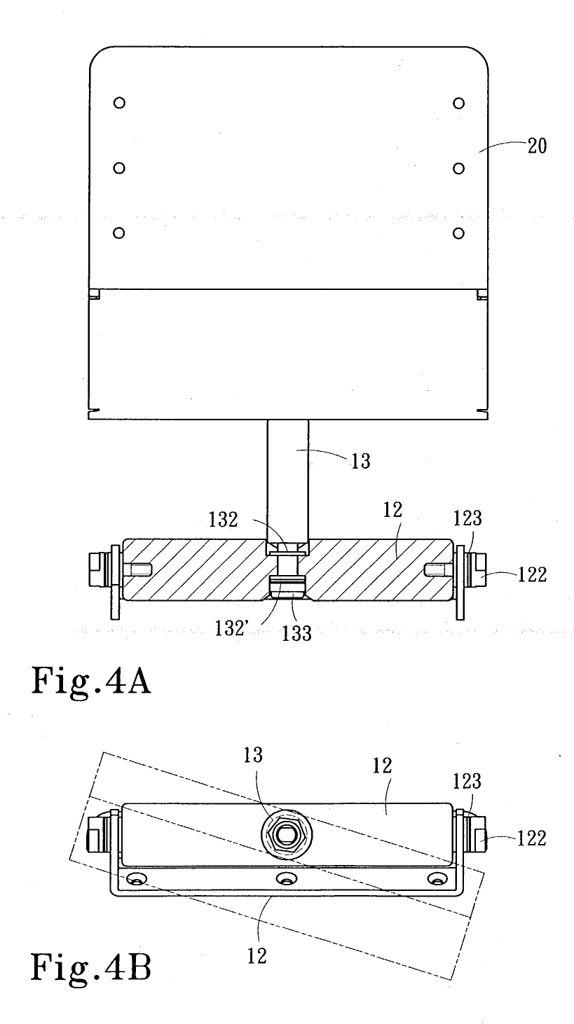

Refer to FIGS. 4A and 4B for the invention in use for turning left or right. When the user applies a force on two sides of the display screen 20, the display screen 20 may be turned left or right through the second axle 13. Because of the second axle 13 runs through the first axle 12, and is pivotally anchored through the second axle washers 132 and 132′ and the second fastener 133, while the display screen 20 is turned left or right, the second retaining section 135 of the second axle 13 (referring to FIG. 2) enables the second axle 13, second axle washers 132 and 132′, and second fastener 133 to turn concurrently, and through the coupling of the second axle washers 132 and 132′ and the second axle 13, the display screen 20 may be turned left or right and anchored in a stepless fashion.

The invention may be adopted for use in sales systems such as cash registers, meal ordering devices or inventory machines. As the display screen of the invention may be tilted forwards and rearwards, and turned left and right in a stepless fashion, the angle of the display screen may be adjusted freely according to where the customers are located.

What is claimed is:

1. A hinge structure for sales systems bridging a body and a display screen, comprising:
an anchor bracket fastening to the body;
a first axle pivotally fastened to the anchor bracket having two ends coupling respectively with a first axle washer; and
a second axle connected to the display screen and pivotally run through the first axle having a pivotal connecting section located on a lower side thereof to pivotally couple with second axle washers;
wherein the display screen is tiltable forwards and rearwards through the first axle and turnable left and right through the second axle.

2. The hinge structure for sales systems of claim 1, wherein the sales systems are selectively cash registers, meal ordering devices or inventory machines.

3. The hinge structure for sales systems of claim 1, wherein the two ends of the first axle are fastened respectively to a first fastener to fasten the first axle washer.

4. The hinge structure for sales systems of claim 3 further having a first washer located between the first fastener and the first axle washer.

5. The hinge structure for sales systems of claim 3, wherein the first fastener has screw threads formed thereon corresponding to the first axle and a first retaining section.

6. The hinge structure for sales systems of claim 1, wherein the pivotal connecting section is fastened to a second fastener for fastening the second axle washers.

7. The hinge structure for sales systems of claim 6 further having a second washer located between the second fastener and the second axle washer.

8. The hinge structure for sales systems of claim 6, wherein the pivotal connecting section has screw threads formed thereon corresponding to the second fastener and a second retaining section.
